(19) United States
(12) Patent Application Publication
(10) Pub. No.: US 2011/0131095 A1
(43) Pub. Date: Jun. 2, 2011

(54) Social network-driven cooperative characterization with non-social network sites

(76) Inventors: Harry R. Soza, San Jose, CA (US); Mark Wayman, Oakland, CA (US); Keith Rose, Alamo, CA (US); Jeffrey A. Roberts, Hayward, CA (US)

(21) Appl. No.: 12/928,735

(22) Filed: Dec. 16, 2010

Related U.S. Application Data
(63) Continuation-in-part of application No. 12/288,614, filed on Oct. 21, 2008.
Application No. 12/288,614 is a continuation-in-part of application No. 12/460,223, filed on Jul. 14, 2009.
Application No. 12/460,223 is a continuation-in-part of application No. 12/804,248, filed on Jul. 16, 2010.
(60) Provisional application No. 61/284,511, filed on Dec. 17, 2009.

(51) Int. Cl. G06Q 30/00

(52) U.S. Cl. 705/14.66

(57) ABSTRACT

A system for cooperative characterization between a social network and computer systems outside the social network but operable within the social network system. Members of the social network are identified by a personal characteristic identifier readable by the outside computer systems.

### CROSS-REFERENCE TO RELATED APPLICATIONS

This application claims priority from U.S. Provisional Patent Application 61/284,511 filed Dec. 17, 2009, which is incorporated herein by reference. This application is a continuation-in-part of U.S. patent application Ser. No. 12/288,614 filed Oct. 21, 2008, which is incorporated herein by reference. This application is also a continuation-in-part of U.S. patent application Ser. No. 12/460,223 filed Jul. 14, 2009, which is incorporated herein by reference. This application is also a continuation-in-part of U.S. patent application Ser. No. 12/804,248 filed Jul. 16, 2010, which is incorporated herein by reference.

### FIELD OF THE INVENTION

The invention relates to social network systems and tailoring of promotional items.

### BACKGROUND OF THE INVENTION

Via the Internet businesses and other organizations present various content to promote their organization's objectives. Sometimes the presentation may be simply static content that informs a user about some aspect of the products or services offered or a special deal regarding the price. Other types of content can include all of the various passive or interactive formats supported by the Internet. For example, this could include video, interactive video, polls or voting widgets, messages, blogs, games, alerts, and many other forms. The essence of all these formats, when presented to a user, is that they are “promotion”—an attempt to engage the User with the business or organization.

The business opportunity is to tailor the promotion to the viewer to increase relevance and impact, and thereby stimulate the viewer to take a desired action.

Traditional Internet sites cannot readily undertake tailored promotion, because users, when they interact with the sites, are essentially anonymous. To provide tailored promotion, a site must have some insight about the user, because such insight is needed to determine which version of a promotion might be most engaging for the User. Technology methods (e.g. cookies, historic URL inference) have been employed to try to infer certain characteristics about a user, and some promotions openly solicit further information. All of these approaches are limited, have critical shortcomings or can only be used in some sort of explicit “user sign-in” mode, which in some business settings is not a desirable method of interaction. The invention advances the art of content promotion in a social network environment.

### SUMMARY AND DESCRIPTION OF THE INVENTION

To maximize the effectiveness of a promotion, it is desirable to present a set of elements (a “version” of the promotion) that may more directly relate to the demographics and/or prior behavior of a consumer. For example, a young woman in San Francisco may favorably respond to certain aspects of a promotion, while an older man in Dallas may respond favorably to different elements of the same promotion; visitors who have already voted for a “fan favorite” probably should see other promotional content on subsequent visits.

In a Social Network (SN) each viewer is consistently identified by the social network using an alphanumeric “tag” that is readable by all outside computer systems operating within the social network technology system; this tag is assigned to each user upon enrollment in the social network and does not vary thereafter. The viewer, in addition to this identifying tag, also has a profile of self-reported characteristics, some of which may be available to the outside computer systems that operate within the social network technology system. This creates an environment where an initial characterization can be made with no explicit request to the user. This characterization can be augmented by tracking the historical SN actions of a user, including the nature and extent of digital pass-along. When a user clicks on a link to leave the SN and go to a non-SN site, it is possible for the hosting technology system to inform the destination site about the user that is now arriving. This can be of significant business value both as a reporting enrichment and potentially as a triggering mechanism to increase engagement.

In an equivalent manner when a user clicks on a link to leave a non-SN and go to an SN site it is possible for the hosting SN technology system to inform the originating site about the user that has now arrived at the SN. This, too, can be of significant business value both as a reporting enrichment and potentially as a triggering mechanism to increase engagement by the user in future visits to the non-SN site.

To be able to take advantage of the inherent characterization that can occur in a SN platform a promotion Sponsor needs a SN technology system that can identify key demographic and prior-use characteristics of SN users, can deliver that information about that characterization through a communication to a non-SN destination site of the Sponsor, and a destination site or originating site that is cooperating with the information transfer and capturing/reacting to the data being supplied.

The invention involves a computer system capable of identifying, using data provided by a social network, specific business-related characteristics of those individuals who view an on-line promotion.

The invention further involves a computer system that tracks the SN activity of the users across the various content, engagement, transactional and sharing activities that are offered in the SN, and records the activity of each element, while maintaining a record of the context of the overall set in which it was presented to a viewer.

The invention further involves a computer system capable of maintaining a database of SN users who have been identified as having greater “influence” in specific domains, and tracking the degree of their interest and receptiveness to specific promotions and to specific elements presented to the viewer as a set.

The invention further involves a data system capable of measuring the “response-impact” that results when a viewer shares the promotion with their social network friends. The response-impact is a measure that combines:

a) Response effectiveness: how effectively do invites to friends create new viewers of the promotion, with

b) Engagement extent: the number and type of activities taken by those who respond to the invites.

The invention further involves a computer system capable of assembling a concise “characterization tag”, using a business-relevant taxonomy, that contains specific elements of information about a SN User. This tag is a string of computer readable characters that, using an encoding system along with the business-relevant taxomony, represents various aspects describing the activity and business-relevant characteristics about a specific SN User (e.g. xxx=repeat visitor to site). The encoding and decoding system is shared among companies that cooperate in utilizing the characterization tag to better conduct business.

The invention further involves a computer system capable of attaching, embedding or encoding the characterization tag into the normal site-to-site communication messages that are used in the Internet.

The invention further involves a computer system capable of receiving Internet communication that contains the characterization tags, extracting the business-relevant information enclosed and utilizing it:

a) as a means of better understanding the characterized user;

b) as a trigger to present user-specific promotional content;

c) both; and/or

d) other types of computer processing that advances the business goals of the site that received the information.

As part of the information that is sent to the cooperating non-social network site, the invention also involves a technology system capable of providing a non-personally identified tracking code, of appropriate form and encoded in appropriate format, that can be utilized by the standard online-merchant affiliate-sales commission system. This form and format, which varies by merchant retail site, can be used to attribute any purchases made during a specific visit back to the social network user. This is useful because these data now can be used in a system of social attribution: linking a purchaser's specific action to a message sent to them by another social network user; a demonstration of social influence that carries an attributable dollar value.

Some aspects of the technology for tracking and determining influence have been described in, for example, U.S. patent application Ser. No. 12/288,614 filed on Oct. 21, 2008 and U.S. patent application 12/460,223 filed on Jul. 14, 2009, which are both incorporated by reference to this patent application in its entirety.

Further details of embodiments of the invention are described in Appendix A (4 pages) by the inventors, which is hereby incorporated in its entirety.

1. A system for cooperative characterization between social networks and non-social networks, comprising:
(a) an online social network communication system with a plurality of social network members, wherein each of said social network members has a personal characteristic identifier, wherein said personal characteristic identifier includes self-reported data by said member and member's engagement activities related to activities within said social network communication system;
(b) an online non-social network sponsoring business system, linked via the Internet with said online social network communication system, presenting promotional items to said social network members on a member's web page within said social network communication system, wherein said member's webpage presents two or more versions of a promotional item from said non-social network sponsoring business system; and
(c) a communication system for communicating said personal characteristic identifier from said a social network member of said social network communication system to said corresponding non-social network sponsoring business system such that when said social network member is viewing said promotional items on its member's web page each one of said presented promotional items are tailored by said non-social network sponsoring business system according to said communicated personal characteristic identifier.
